(19) United States
(12) Patent Application Publication
(10) Pub. No.: US 2009/0032777 A1
(43) Pub. Date: Feb. 5, 2009

(54) CARBON NANOTUBE DISPERSION LIQUID AND TRANSPARENT CONDUCTIVE FILM USING SAME

(75) Inventors: Takahiro Kitano, Ibaraki (JP); Masayasu Ogushi, Niigata (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KURARAY CO., LTD., KURASHIKI-SHI (JP)

(21) Appl. No.: 11/916,869

(22) PCT Filed: Jun. 6, 2006
(86) PCT No.: PCT/JP2006/311343

§ 371 Date: Apr. 4, 2008

(30) Foreign Application Priority Data
Jun. 7, 2005 (JP) 2005-166458

(51) Int. Cl. H01B 1/24; B05D 5/12

(52) U.S. Cl. 252/510; 427/77; 977/779

(57) ABSTRACT

Disclosed is a carbon nanotube dispersion liquid which enables to easily form a transparent conductive film. Also disclosed is a transparent conductive film obtained by using such a carbon nanotube dispersion liquid. Specifically disclosed is a carbon nanotube dispersion liquid containing a carbon nanotube (A), a dispersing agent (B) composed of an organic compound containing one of a carboxyl group, epoxy group, amino group and sulfonyl group and having a boiling point of not less than 30&ring;C and not more than 150&ring;C, and a solvent (C). Also disclosed are a transparent conductive film containing a layer composed of a solid component of such a dispersion liquid, and a method for producing such a transparent conductive film.

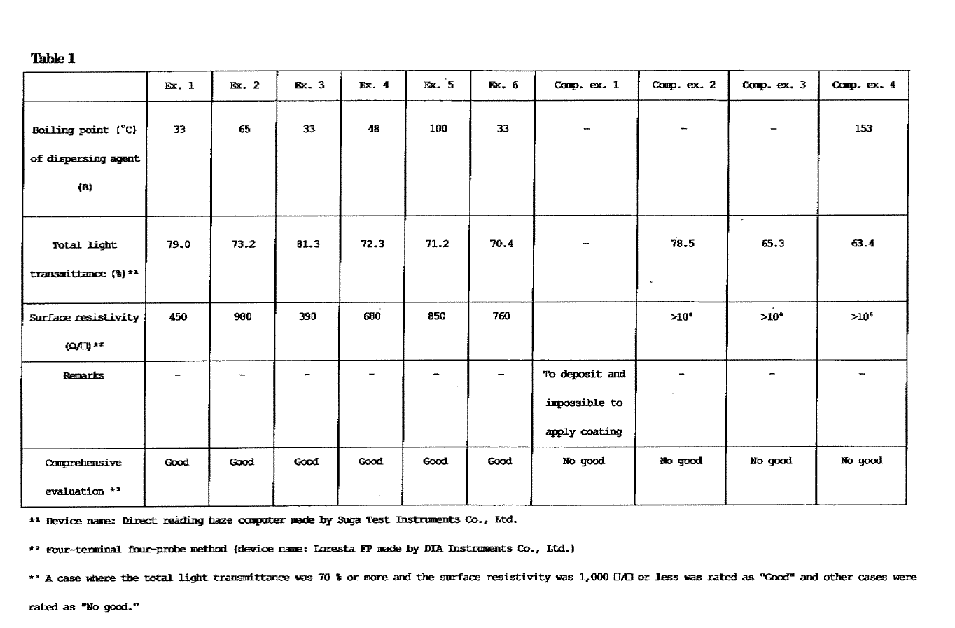

### TECHNICAL FIELD

The present invention relates to a carbon nanotube dispersion liquid and a transparent conductive film using the carbon nanotube dispersion liquid, in particular a carbon nanotube dispersion liquid the application of which yields a film having a higher electrical conductivity.

### BACKGROUND ART

Recently, as the market of thin display devices represented by liquid crystal displays expands, demand for transparent conductive films is rapidly increasing. Transparent conductive films are used for various applications such as electrodes, members constituting resistive film touch panels, and electromagnetic shielding films. However, most of the transparent conductive films currently used in the market are made of indium tin composite oxide (hereafter ITO), thus they use indium having a high scarcity value, and therefore they are getting hardly available. Under the circumstances, a variety of alternative technologies are proposed and a transparent conductive film coated with carbon nanotube is proposed as one of the alternative technologies.

Since carbon nanotube is hardly dispersible in a solvent, however, many kinds of dispersing agents are proposed. The examples are: dispersing agents using salt such as sodium dodecyl sulfate, and cationic lipid which has a hydrophobic group and a hydrophilic group (Patent Document 1); and dispersing agents using polymers, such as a compound having a hydrophobic-hydrophilic-hydrophobic part structure (Patent Document 2), a heterocyclic compound trimer (Patent Document 3), a fluorine-containing polymer (Patent Document 4), and a water-soluble polymer (Patent Document 5). Further, another proposed technology is that the surface of carbon nanotube is modified with a functional group by utilizing the amide linkage in combining octadecylamine with dichlorocarbene so as to improve dispersibility (Non-patent Document 1).

These technologies are superior in dispersing carbon. However, the problems of those technologies as a method for forming a transparent conductive film have been that increasing the amount of a dispersing agent improves dispersibility but relatively lowers the content of carbon nanotube which is a conductive component, and therefore electric conductivity lowers, a process of removing an unnecessary dispersing agent is required, and a process of modifying a surface is complicated. Usually, when a dispersing agent is removed after carbon nanotube is dispersed with the dispersing agent, a complicated method of picking up only solid contents by filtering or centrifugal separation and thereafter washing away the excessive dispersing agent with water is adopted.

### Patent Document 1: Japanese Unexamined Patent Application Publication No. 2004-082663

### Patent Document 2: Japanese Unexamined Patent Application Publication No. 2003-238126

### Patent Document 3: Japanese Unexamined Patent Application Publication No. 2004-167667

### Patent Document 4: Japanese Unexamined Patent Application Publication No. 2004-261713

### Patent Document 5: Japanese Unexamined Patent Application Publication No. 2004-531442

### Non-patent Document 1: Science, Vol. 282, p95 (1998)

Non-patent Document 2: Appl. Phs. A 67, 29-37

### DISCLOSURE OF THE INVENTION

### Problem to be Solved by the Invention

In view of the above situation, an object of the present invention is to provide: a carbon nanotube dispersion liquid which enables a transparent conductive film to be easily formed; and a transparent conductive film obtained by using such a carbon nanotube dispersion liquid.

### Means for Solving the Problem

The inventors of the present invention, as a result of earnest studies, have found that, when a dispersing agent of a low boiling point is used, the dispersing agent can be removed by heating after coating. Then, as a result of further studies, the present inventors have achieved a carbon nanotube dispersion liquid which can solve the aforementioned problems and a transparent conductive film obtained by using the dispersion liquid.

The present invention is a carbon nanotube dispersion liquid containing carbon nanotube (A), a dispersing agent (B), and a solvent (C), wherein the dispersing agent (B) is an organic compound containing at least one kind selected from among the group of a carboxyl group, an epoxy group, an amine group, and a sulfonyl group and having a boiling point of not lower than 30° C. and not higher than 150° C.

Further, the present invention is a carbon nanotube dispersion liquid that satisfies the following expressions (1) and (2), when an amount (mass percentage) of the carbon nanotube (A), an amount (mass percentage) of the dispersing agent (B), and an amount (mass percentage) of the solvent (C) are represented by (Awt), (Bwt), and (Cwt), respectively:

0.0001≦(Awt)/{(Awt)+(Bwt)+(Cwt)}≦0.1 (1), and

0.3≦(Bwt)/{(Awt)+(Bwt)}<1.0 (2).

Furthermore, the present invention is a carbon nanotube dispersion liquid wherein the dispersing agent (B) is a compound containing an amino group, and particularly the compound is at least one kind selected from among the group of n-propylamine, iso-propylamine, n-butylamine, and sec-butylamine.

In addition, the present invention is a transparent conductive film including a layer comprising a solid component in the carbon nanotube dispersion liquid as well as a method for producing the transparent conductive film including the processes of applying the carbon nanotube dispersion liquid to a base material and removing the dispersing agent (B) and the solvent (C) by heating.

### EFFECT OF THE INVENTION

A carbon nanotube dispersion liquid according to the present invention enables a transparent conductive film to be formed not through any complicated process but only through coating and successive heating, and therefore can be advantageously used for a transparent electrode, a touch panel member, and an electromagnetic shielding material.

### BEST MODE FOR CARRYING OUT THE INVENTION

A carbon nanotube dispersion liquid according to the present invention is a composition containing carbon nanotube (A), a dispersing agent (B), and a solvent (C), wherein the dispersing agent (B) is an organic compound containing at least one kind selected from among the group of a carboxyl group, an epoxy group, an amino group, and a sulfonyl group and having a boiling point of not lower than 30° C. and not higher than 150° C. Each of the components is explained hereunder.

The carbon nanotube (A) is not particularly limited as long as it is known carbon nanotube. The examples are single wall carbon nanotube, double wall carbon nanotube, multi wall carbon nanotube, and the like. Alternatively, the carbon nanotube (A) may be intertwined into the shape of plural ropes or may have a branch structure. Alternatively, the carbon nanotube (A) as produced can also be used but it is more desirable to use carbon nanotube after it is more purified by a process of removing impurities. As methods for refining carbon nanotube, a method of heating the carbon nanotube in a vacuum and a method of applying acid treatment are known. It is also known that, by the acid treatment, a hydroxyl group and a carboxyl group are generated on a side-chain of carbon nanotube. It is desirable to apply the refining method by the acid treatment to carbon nanotube according to the present invention because it is more desirable that the carbon nanotube has a good adsorptivity to the dispersing agent (B).

The method of acid treatment is not particularly limited as long as it is such a known method as described in Non-patent Document 2. More specifically, as acid used in the acid treatment, nitric acid, sulfuric acid, hydrochloric acid, phosphoric acid, and a mixture thereof are desirably used, and nitric acid or a mixture of nitric acid and sulfuric acid is used more desirably. It is acceptable to apply acid treatment during heating.

There are no particular limits in the length and the diameter of a fiber of carbon nanotube used in the present invention. However, if a fiber is too long, the carbon nanotube hardly disperses when a coating liquid is produced and, if a fiber is too short, electric conductivity is hardly secured. Consequently, a length of a conductive fiber is desirably not less than 100 nm and not more than 100 μm, and more desirably not less than 1 μm and not more than 10 μm. When the diameter of a conductive fiber is too small, the carbon nanotube is hardly formed and, when it is too large, the whole light transmittance lowers. Consequently, a diameter of a conductive fiber is desirably not less than 1 nm and not more than 1 μm, and more desirably not less than 1 nm and not more than 200 nm.

The dispersing agent (B) is a component necessary for dispersing carbon nanotube in a solvent but the dispersing agent used in the present invention is required to be removed by heating after coating. Consequently, the dispersing agent (B) must have a boiling point of not lower than 30° C. and not higher than 150° C. A boiling point of not lower than 60° C. and not higher than 130° C. is more desirable.

Further, it is necessary for the dispersing agent to have at least one kind selected from among the group of a carboxyl group, an epoxy group, an amino group, and a sulfonyl group as a functional group susceptible to being adsorbed by carbon nanotube. Concrete examples are: carboxylic compounds including formic acid and acetic acid; epoxy compounds including propylene oxide, 1,2-epoxybutane, and (cis, trans) 2,3-epoxybutane; primary amine compounds including n-propylamine, iso-propylamine, N-ethyl methylamine, n-butylamine, sec-butylamine, iso-butylamine, tert-butylamine, n-amylamine, tert-amylamine, iso-amylamine, and hexylamine; secondary amine compounds including diethylamine, N-methyl propyl amine, N-methyl isopropyl amine, N-ethyl isopropyl amine, N-methyl butyl amine, 2-methyl butyl amine, N-methyl-tert-butyl amine, di-isopropyl amine, dipropyl amine, N-ethyl butyl amine, N-methyl pentyl amine, N-tert-butyl isopropyl amine, and N-propyl butyl amine; and tertiary amine compounds including N,N-diethyl methyl amine, 1,2-dimethyl propyl amine, 1,3-dimethyl butyl amine, 3,3-dimethyl butyl amine, triethylamine, N-methyl diisopropyl amine, N,N-diisopropyl ethyl amine, N-isopropyl-N-methyl-tert-butyl amine, and tri-isopropyl amine. Among them, primary amine compounds are desirable, and n-propyl amine, isopropyl amine, n-butyl amine, and sec-butyl amine are more desirable.

The solvent (C) is not particularly limited as long as it is an ordinary solvent used for a paint. The examples are: ketone compounds including acetone, methyl ethyl ketone, methyl isobutyl ketone, and cyclohexanone; ester compounds including methyl acetate, ethyl acetate, butyl acetate, ethyl lactate, and methoxyethyl acetate; ether compounds including diethyl ether, ethylene glycol dimethyl ether, ethyl cellosolve, butyl cellosolve, phenyl cellosolve, and dioxane; aromatic compounds including toluene and xylene; aliphatic compounds including pentane and hexane; halogen hydrocarbons including methylene chloride, chlorobenzene, and chloroform; alcohol compounds including methanol, ethanol, n-propanol, and isopropanol; and water.

When the compounding ratio of the carbon nanotube (A) to the whole dispersion liquid is large, the carbon nanotube does not disperse but deposits and in contrast, when the ratio is small, the coating amount increases excessively during coating. Consequently, it is desirable that the following expression (1) is satisfied when an amount (mass percentage) of the carbon nanotube (A), an amount (mass percentage) of the dispersing agent (B), and an amount (mass percentage) of the solvent (C) are represented by (Awt), (Bwt), and (Cwt), respectively:

0.0001≧(Awt)/{(Awt)+(Bwt)+(Cwt)}≧0.1 (1).

It is further desirable that the following expression (3) is satisfied:

0.001≦(Awt)/{(Awt)+(Bwt)+(Cwt)}≦0.01 (3).

Meanwhile, when the compounding ratio of the dispersing agent (B) to the whole dispersion liquid is small, the dispersibility of carbon nanotube lowers. Consequently, it is desirable that the following expression (2) is satisfied when an amount (mass percentage) of the carbon nanotube (A), an amount (mass percentage) of the dispersing agent (B), and an amount (mass percentage) of the solvent (C) are represented by (Awt), (Bwt), and (Cwt), respectively:

0.3≦(Bwt)/{(Awt)+(Bwt)}≦1.0 (2).

It is further desirable that the following expression (4) is satisfied:

0.5≦(Bwt)/{(Awt)+(Bwt)+(Cwt)}≦0.99 (4).

A dispersion liquid according to the present invention may contain, if needed within the range not hindering the effects of the present invention: thermoplastic resin including acrylic, polyester, polycarbonate, polystyrene, styrene-acrylic copolymer, vinyl chloride resin, polyolefin, ABS (acrylonitrile-butadiene-styrene copolymer), cycloolefin resin, vinyl acetate, butyral, and epoxy; photo-setting resin; thermosetting resin; and a leveling agent.

Though a dispersion liquid according to the present invention can be produced by just simply blending the components stated above, it is preferable to enhance dispersibility by imposing mechanical shearing force. More specifically, a roll mill, a beads mill, a ball mill, ultrasonic irradiation, shock wave bombardment using turbulence generation, or another measure is used.

Further, the present invention is a method for forming a transparent conductive film on a base material, and specifically a method for forming a transparent conductive film, the method including the processes of: coating a base material with a dispersion liquid according to any one of Claims 1 to 5; and removing the dispersing agent (B) and the solvent (C) by heating.

The base material used for forming a transparent conductive layer according to the present invention is not particularly limited as long as it is a known material. If the application of a transparent conductive film according to the present invention is taken into consideration, however, a transparent base material is desirable. Concrete examples are acrylic, polyester, polycarbonate, polystyrene, styrene-acrylic copolymer, vinyl chloride resin, polyolefin, ABS (acrylonitrile-butadiene-styrene copolymer), cycloolefin resin, cellulosic resin, and glass.

With regard to the shape of the base material, a sheet shape or a film shape is desirable, and a corrugated shape or a non-flat shape is also acceptable.

Further, if needed, it is also acceptable to use a base material produced by laminating a hard coated layer, an antifouling layer, an anti-glare layer, an antireflection layer, or an adhesive layer beforehand on the coated surface or on the surface opposite the coated surface of the base material.

The method for applying a dispersion liquid according to the present invention to a base material is not particularly limited as long as it is a known method.

Examples of the method are an impregnating method, a coating method with a roll, a die coating method, a wire-bar coating method, a method of spraying on a base material, and a curtain flow coating method. It is also possible to make a print of a desired pattern by the method of screen printing, relief printing, intaglio printing, or gravure printing.

The process of removing a dispersing agent (B) and a solvent (C) by heating is not particularly limited as long as it is a known process. The examples are a process in a heating furnace and a process in a far-infrared furnace. Heating temperature varies in response to a used base material and generally is not lower than 80° C. and not higher than 150° C.

A transparent conductive film according to the present invention can be used as it is and, if necessary, may be laminated with a hard coated layer, an antifouling layer, an anti-glare layer, an antireflection layer, or an adhesive layer. It is also possible to form a desired shape by etching if necessary.

### BEST MODE FOR CARRYING OUT THE INVENTION

### Examples

The present invention is hereunder explained concretely on the basis of examples. However the present invention is not limited to those examples.

### Example 1

A dispersion liquid was produced by: mixing 10 mg of single wall carbon nanotube (made by Carbolex Inc.), 1 g of isopropylamine, and 9 g of methyl isobutylketone; and irradiating the mixture with ultrasound for one hour (the model name of the device: ULTRASONIC HOMOGENIZER MODEL UH-600SR made by SMT Co., Ltd.) while the mixture was kept cool with ice water.

### Example 2

A dispersion liquid was produced by: mixing 10 mg of multi wall carbon nanotube (made by SUNNANO), 1 g of sec-isobutylamine, and 9 g of methyl isobutylketone; and irradiating the mixture with ultrasound for one hour (model name of the device: ULTRASONIC HOMOGENIZER MODEL UH-600SR made by SMT Co., Ltd) while the mixture was kept cool with ice water.

### Example 3

A dispersion liquid was produced by: mixing 10 mg of single wall carbon nanotube (made by Carbolex Inc.) subjected to reflux heating treatment in a 3 mol/l nitric acid aqueous solution for 48 hours, 1 g of isopropylamine, and 9 g of methyl isobutylketone; and irradiating the mixture with ultrasound for one hour (the model name of the device: ULTRASONIC HOMOGENIZER MODEL UH-600SR made by SMT Co., Ltd) while the mixture was kept cool with ice water.

### Example 4

A dispersion liquid was produced by: mixing 10 mg of single wall carbon nanotube (made by Carbolex Inc.) subjected to reflux heating treatment in a 3 mol/l nitric acid aqueous solution for 48 hours, 1 mg of propylamine, and 9 g of water; and irradiating the mixture with ultrasound for one hour (the model name of the device: ULTRASONIC HOMOGENIZER MODEL UH-600SR made by SMT Co., Ltd) while the mixture was kept cool with ice water.

### Example 5

A dispersion liquid was produced by: mixing 10 mg of single wall carbon nanotube (made by Carbolex Inc.) subjected to reflux heating treatment in a 3 mol/l nitric acid aqueous solution for 48 hours, 100 mg of formic acid, and 9 g of water; and irradiating the mixture with ultrasound for one hour (the model name of the device: ULTRASONIC HOMOGENIZER MODEL UH-600SR made by SMT Co., Ltd) while the mixture was kept cool with ice water.

### Example 6

A dispersion liquid was produced by: mixing 10 mg of single wall carbon nanotube (made by Carbolex Inc.) subjected to reflux heating treatment in a 3 mol/l nitric acid aqueous solution for 48 hours, 1 g of isopropylamine, 8 g of water, and 1 g of butylcellosolve; and irradiating the mixture with ultrasound for one hour (the model name of the device: ULTRASONIC HOMOGENIZER MODEL UH-600SR made by SMT Co., Ltd) while the mixture was kept cool with ice water.

### Comparative Example 1

A dispersion liquid was produced by: mixing 10 mg of single wall carbon nanotube (made by Carbolex Inc.), 10 mg of polyesteramide amine salt (trade name: DISPARLON DA-725 made by Kusumoto Chemicals, Ltd.), and 10 g of methyl isobutylketone; and irradiating the mixture with ultrasound for one hour (the model name of the device: ULTRASONIC HOMOGENIZER MODEL UH-600SR made by SMT Co., Ltd) while the mixture was kept cool with ice water.

### Comparative Example 2

A dispersion liquid was produced by: mixing 10 mg of single wall carbon nanotube (made by Carbolex Inc.), 100 mg of polyesteramide amine salt (trade name: DISPARLON DA-725 made by Kusumoto Chemicals, Ltd.), and 10 g of methyl isobutylketone; and irradiating the mixture with ultrasound for one hour (the model name of the device: ULTRASONIC HOMOGENIZER MODEL UH-600SR made by SMT Co., Ltd) while the mixture was kept cool with ice water.

### Comparative Example 3

A dispersion liquid was produced by: mixing 10 mg of single wall carbon nanotube (made by Carbolex Inc.), 100 mg of sodium dodecyl sulfate, and 10 g of water; and irradiating the mixture with ultrasound for one hour (the model name of the device: ULTRASONIC HOMOGENIZER MODEL UH-600SR made by SMT Co., Ltd) while the mixture was kept cool with ice water.

### Comparative Example 4

A dispersion liquid was produced by: mixing 10 mg of single wall carbon nanotube (made by Carbolex Inc.), 100 mg of N,N-dimethylformamide, and 10 g of water; and irradiating the mixture with ultrasound for one hour (the model name of the device: ULTRASONIC HOMOGENIZER MODEL UH-600SR made by SMT Co., Ltd) while the mixture was kept cool with ice water.

### Production of Transparent Conductive Film

Transparent conductive films were produced by: coating polyethylene terephthalate films (trade name: Toyobo ESTER FILM E5001, film thickness: 188 μm, made by Toyobo Co., Ltd.) with the dispersion liquids obtained in Examples 1 to 6 and Comparative Examples 1 to 4, respectively, with a bar coater so that the coating thickness of the solid component might be 20 nm; and thereafter drying at 100° C. for 3 minutes. The total light transmittance and the surface resistivity of each of the produced transparent conductive films are shown on Table 1.

### [Table 1]

As it is obvious from the results shown on Table 1, particularly the results obtained by Examples 1 to 6, a transparent conductive film can be easily formed by using a dispersion liquid according to the present invention. In contrast, it is shown that, in the cases of not using the dispersing agent (B) according to the present invention as shown in Comparative Examples 1 to 4, production of a film fails with a small amount of a dispersing agent and the surface resistivity of a produced film is not small enough with a large amount of a dispersing agent.

1: A carbon nanotube dispersion liquid comprising: a carbon nanotube (A), a dispersing agent (B), and a solvent (C), wherein the dispersing agent (B) is an organic compound comprising at least one group selected from the group consisting of a carboxyl group, an epoxy group, an amine group, and a sulfonyl groups and having a boiling point of not lower than 30° C. and not higher than 150° C.

2: The carbon nanotube dispersion liquid according to claim 1, wherein the carbon nanotube dispersion liquid satisfies the following expressions (1) and (2), when an amount (mass percentage) of the carbon nanotube (A), an amount (mass percentage) of the dispersing agent (B), and an amount (mass percentage) of the solvent (C) are represented by (Awt), (Bwt), and (Cwt), respectively:
0.0001≦(Awt)/{(Awt)+(Bwt)+(Cwt)}<0.1 (1), and
0.3≦(Bwt)/{(Awt)+(Bwt)}≦1.0 (2).

3: The dispersion liquid according to claim 1, wherein the carbon nanotube (A) is single wall carbon nanotube.

4: The dispersion liquid according to claim 1, wherein the dispersing agent (B) is a compound having an amino group.

5: The dispersion liquid according to claim 4, wherein the compound having an amino group is at least one compound selected from the group consisting of n-propylamine, isopropylamine, n-butylamine, and sec-butylamine.

6: The dispersion liquid according to claim 1, wherein the carbon nanotube (A) is subjected to acid treatment.

7: A transparent conductive film comprising a layer comprising a solid component in the dispersion liquid according to claim 1.

8: A method for forming the transparent conductive film according to claim 7 on a base material, comprising: coating the base material with the dispersion liquid according to claim 1; and removing the dispersing agent (B) and the solvent (C) by heating.
